(19) United States
(12) Patent Application Publication
(10) Pub. No.: US 2013/0141313 A1
(43) Pub. Date: Jun. 6, 2013

(54) WEARABLE PERSONAL DIGITAL EYEGLASS DEVICE

(71) Applicants: Tiger T.G. Zhou, Tiburon, CA (US); Dylan T.X. Zhou, San Gabriel, CA (US); Andrew H.B. Zhou, Tiburon, CA (US)

(72) Inventors: Tiger T.G. Zhou, Tiburon, CA (US); Dylan T.X. Zhou, San Gabriel, CA (US); Andrew H.B. Zhou, Tiburon, CA (US)

(21) Appl. No.: 13/753,855

(22) Filed: Jan. 30, 2013

Related U.S. Application Data
(63) Continuation-in-part of application No. 13/185,491, filed on Jul. 18, 2011.

(51) Int. Cl. G02B 27/01

(52) U.S. Cl. CPC G02B 27/017
USPC 345/8

(57) ABSTRACT

Provided are a wearable personal digital eyeglass device and a method for interfacing a user with a wearable personal digital eyeglass device. The wearable personal digital eyeglass device may comprise a right earpiece and a left earpiece connected by a cable, a nosepiece portion consisting of a right nosepiece and a left nosepiece connected to each other by a connector, a display, a transceiver, an earphone, and a sensor. The right nosepiece may be connected to the right earpiece, and the left nosepiece may be connected to the left earpiece of the wearable personal digital eyeglass device. The transceiver may be configured to receive data from a control device, receive one or more commands of the user, and transmit the data and the one or more commands to the control device.

### CROSS-REFERENCE TO RELATED APPLICATIONS

This application is a continuation-in-part of U.S. patent application Ser. No. 13/185,491, entitled “FACILITATING MOBILE DEVICE PAYMENTS USING PRODUCT CODE SCANNING,” filed on Jul. 18, 2011, which is incorporated herein by reference in its entirety.

### FIELD

This application relates generally to wearable personal digital interfaces and, more specifically, to an eyeglass device adapted for viewing and hearing signals from remote devices.

### BACKGROUND

Increased functionality of wearable personal digital interfaces has led to their popularity. Eyewear having a display and earphones is currently proposed on the market, and usually such eyewear tends to have an appearance of conventional eyeglasses. However, long-term constant wearing of such a bulky device may cause inconvenience to the users. For example, when the user wants to concentrate on some task or to view some objects carefully, the wearable interface will impede visual activity of the user. Therefore, the user will need to take off the wearable interface. After taking off the wearable interface, the user will need to put the wearable interface into his pocket, special case, bag, or to hold the visual interface in his hands.

In addition to that, when taking off the wearable interface in public places, such as cafes, offices, sports facilities, and the like, the wearable interface may be lost there. Moreover, the user may need to take off the wearable interface at the moment when his hands are busy and he cannot hold the wearable interface.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are a wearable personal digital (WPD) eyeglass device and a method for interfacing a user with the WPD eyeglass device.

In certain embodiments, the WPD eyeglass device may include two earpiece portions: a right earpiece and a left earpiece. The right earpiece and the left earpiece may be connected to each other by a cable. Furthermore, the WPD eyeglass device may include a nosepiece portion. The nosepiece portion may consist of two pieces: a right nosepiece and a left nosepiece. The right nosepiece and the left nosepiece may be connected to each other by a connector. In addition to that, the right nosepiece and the left nosepiece may be connected to the right earpiece and the left earpiece correspondingly. The user may connect the right nosepiece and the left nosepiece by means of the connector and put on the WPD eyeglass device and, furthermore, the user may disconnect the right nosepiece and the left nosepiece and leave two parts of the WPD eyeglass device, being connected by the cable, hanging on his neck.

Furthermore, the WPD eyeglass device may include a display being configured to display data to the user. In further embodiments, the WPD eyeglass device may include a transceiver. The transceiver may be configured to receive data from a control device, receive commands of the user, and transmit the data and the commands to the control device. Furthermore, the WPD eyeglass device may include earphones mounted on the earpieces. The WPD eyeglass device may include a sensor configured to sense commands of the user.

In certain embodiments, a method for interfacing a user with a WPD eyeglass device may include receiving, via a transceiver of the WPD eyeglass device, data from a control device. Furthermore, the method may involve displaying the data to the user on a display of the WPD eyeglass device.

In further embodiments, a method for interfacing a user with a WPD eyeglass device may include receiving, via a sensor of the WPD eyeglass device, a command from the user. In further embodiments, the method may involve transmitting, via a transceiver of the WPD eyeglass device, the command to a control device.

In further embodiments, the WPD eyeglass device may be used for facilitating mobile device payments using product code scanning.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 illustrates an environment within which a WPD eyeglass device and a method for interfacing a user with a WPD eyeglass device may be implemented, in accordance with an example embodiment.

FIG. 2 is a schematic representation of a WPD eyeglass device, in accordance with an example embodiment.

FIG. 3 is a schematic representation of a WPD eyeglass device, in accordance with an example embodiment.

FIG. 4 is a flow chart illustrating a method for interfacing a user with a WPD eyeglass device, in accordance with an example embodiment.

FIG. 5 is a flow chart illustrating a method for interfacing a user with a WPD eyeglass device, in accordance with an example embodiment.

FIG. 6 shows a payment performed by the WPD eyeglass device, in accordance with an example embodiment.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

A WPD eyeglass device and methods for interfacing a user with a WPD eyeglass device are described herein. The WPD eyeglass device allows a user to visually access various information by looking at a display attached to glasses. Being worn by the user, the WPD eyeglass device may provide for convenient carrying in many situations and environments, such as physical activity, sports, travels, shopping, telephone conversations, leisure time, and so forth.

The WPD eyeglass device may be wirelessly connected to a phone. In this case, the user may have access to the information stored on the phone and may review the information on the display of the WPD eyeglass device. Furthermore, with the help of the WPD eyeglass device, the user may perform all the functions of the phone remotely, such as accept or decline phone calls, make phone calls, listen to the music stored on the phone, a remote device or accessed via the Internet, control an application running on the phone, control devices the phone is currently connected to, such as a computer, a TV, an audio or video system, and so forth. Additionally, the WPD eyeglass device may allow the user to make a photo or video and upload it to a remote device or to the Internet.

In some embodiments, a phone may be a part of the WPD eyeglass device. In this case, the phone may be mounted on the WPD eyeglass device.

Wearing the WPD eyeglass device during a long period of time, for example, during the entire day, may not be convenient for the user, so the user may repeatedly take off and on the WPD eyeglass device during the day. Therefore, so that the user could easily take off the WPD eyeglass device and still have the WPD eyeglass device easy to access, the WPD eyeglass device may be a two-part device with a nosepiece portion consisting of two pieces that can be easily detached from each other. Furthermore, the WPD eyeglass device may have two earpiece portions connected to each other, for example, by a cable. When the user does not want to use the WPD eyeglass device, he may take apart the nosepiece portion into two parts and put the two parts of the WPD eyeglass device around his neck. Since the earpiece portions of the WPD eyeglass device are connected to each other by the cable, the two-part WPD eyeglass device may be hanging on the neck of the user. When the user wants to use the WPD eyeglass device again, he may joint two pieces of the nosepiece portion hanging on the neck and put on the WPD eyeglass device.

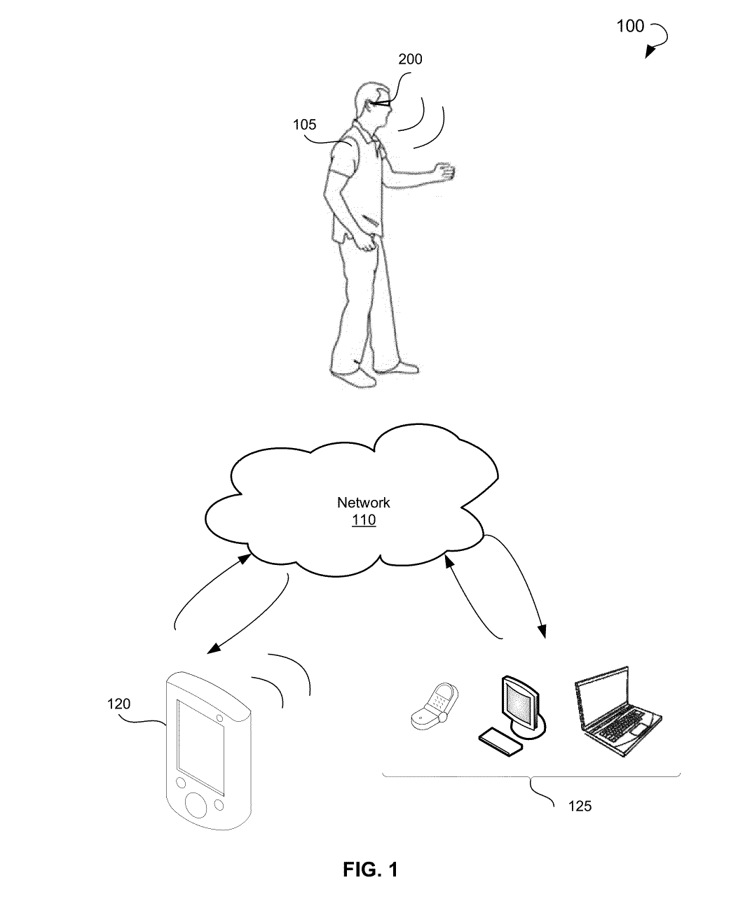

Referring now to the drawings, FIG. 1 illustrates an environment 100 within which a user 105 wearing a WPD eyeglass device 200 and methods for interfacing the user 105 with the WPD eyeglass device 200 can be implemented. The environment 100 may include a user 105, a WPD eyeglass device 200, a communication network 110, a phone 120, and one or more external devices 125.

The phone 120 may include a mobile phone, a smart phone, a personal digital assistant, a tablet PC, and so forth. The user 105 wearing the device 200 may interact with the phone 120 via a bidirectional communication network 110. The network 110 may include wireless radio frequency (RF) communication that may employ one or more of the following: Bluetooth, Wi-Fi, and Near Field Communication (NFC).

The user 105 wearing the device 200 may interact via the bidirectional communication network 110 with the one or more external devices 125. The one or more external devices 125 may include a Global Positioning System (GPS) station, a Personal Digital Assistant (PDA), a personal computer (e.g., a tablet or a laptop), a house signaling system, and the like.

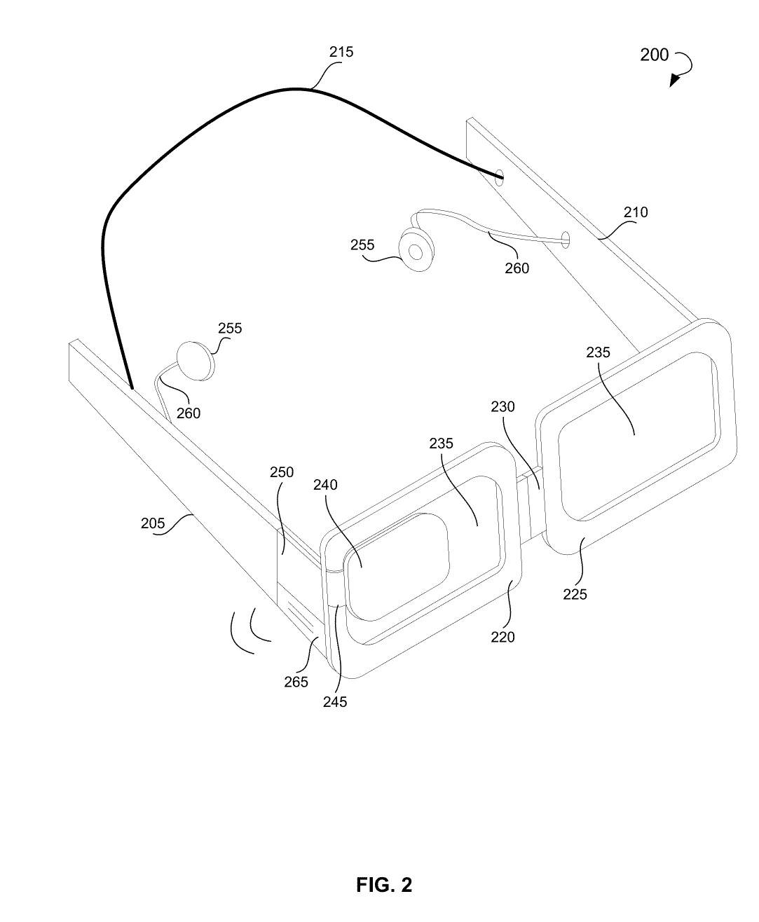

FIG. 2 shows a schematic representation of an exemplary WPD eyeglass device 200. The device 200 may comprise two earpiece portions: a right earpiece 205 and a left earpiece 210. The right earpiece 205 and the left earpiece 210 may be connected by a cable 215. The cable 215 may include a digital cable, a strap, a string, a cord, and the like.

The device 200 may comprise a winding means connected to the cable 215 for winding the cable. When the user 105 presses the winding means, the cable may be wound inside the winding means. The length of the cable 215 may be regulated by the user 105 by winding the cable entirely into the winding means or winding a part of the length of the cable 105 into the winding means.

The device 200 may also comprise a nosepiece portion consisting of a right nosepiece 220 and a left nosepiece 225. The right nosepiece 220 and the left nosepiece 225 may be connected to each other by a connector 230. The connector 230 may include two magnets, one being on the right nosepiece 220 and the other being on the left nosepiece 225. When two parts of the connector 230 are connected, the connector 230 may look like a nose bridge of ordinary eyeglasses. Furthermore, the connector 230 may include a clasp, a hook and loop lock, and the like. The right nosepiece 220 may be connected to the right earpiece 205 and the left nosepiece 225 may be connected to the left earpiece 210. In some embodiments, the right nosepiece 220 may be integrally coupled to the right earpiece 205 and the left nosepiece 225 may be integrally coupled to the left earpiece 210.

The right nosepiece 220 and the left nosepiece 225 may comprise openings for disposing lenses 235. The lenses 235 may include prescription lenses, such as lenses for short-sighted, long-sighted, or astigmatic eyes, non-prescription lenses, such as darkened lenses, safety lenses, and the like. In a certain embodiment, the right nosepiece 220 and the left nosepiece 225 may be implemented without openings and, therefore, without lenses. In this embodiment, the nosepieces 220, 225 may have a width allowing the nosepieces 220, 225 not to overlap the eye sight line of the user 105. In a certain embodiment, at least one lens 235 may include a lens selected according to real eye vision of the user 105, thus allowing the user 105 to see the world around him without any limitations.

The device 200 may also comprise a display 240 configured to display data to the user 105. The display 240 may be mounted to the right nosepiece 220, the left nosepiece 225, the right earpiece 205, or left earpiece 210 by a mounting unit 245. The display 240 may include a liquid crystal display (LCD), an organic LCD, a light emitting diode (LED) display, and so forth. The display 240 may be configured to graphically display one or more of the following: video data, text data, payment data, personal data, barcode information, time data, notifications, and so forth. The barcode information of the product may include product payment information. The device 200 may include a display panel and a circuit that drives the display panel. The display 240 may be disposed directly in front of an eye sight line or outside the eye sight line of the user 105, for example, in the right upper corner or the right lower corner of the right nosepiece 220, or in the left upper corner or the left lower corner of the left nosepiece 225. The mounting unit 245 may be configured to allow adjustment of viewing angle of the display 240. The display 240 may be configured to display simultaneously data requested by the user to be shown and a picture of the real world around the user. In case of such embodiment, the data may be overlaid on the picture of the real world. Furthermore, the display 240 may be segmented into several sections enabling the user to see several types of data in different sections simultaneously.

In certain embodiments, the device 200 may be configured to allow the user 105 to view data in 3D format. In this embodiment, the device 200 may comprise two displays 240, one being mounted on the left nosepiece 225 and another being mounted on the right earpiece 205. Viewing the data in 3D format may be used, for example, when working with such applications as games, simulators, and the like. The device 200 may be configured to enable head tracking. The user 105 may control, for example, video games by simply moving his head, Video game application with head tracking may use 3D effects to coordinate actual movements of the user 105 in the real world with his virtual movements in a displayed virtual world. The virtual display seen by the user 105 by means of the device 200 may correspond to a 20-120-inch display seen by the user 105 when not wearing the device 200. For example, the display 240 may be configured to show a 20-inch virtual display.

Furthermore, the device 200 may comprise a transceiver 250 configured to receive data from a control device, receive one or more commands of the user 105, and transmit the data and the one or more commands to the control device. The control device may include a phone 120 and one or more external devices 125. The transceiver 250 may be mounted to the right nosepiece 220, the left nosepiece 225, the right earpiece 205, or the left earpiece 210.

Furthermore, the device 200 may comprise one or more earphones 255 mounted on the right earpiece 205 or the left earpiece 210. The earphones 255 may be connected to the right earpiece 205 or the left earpiece 210 by a cord 260. The earphones 255 may play sounds received by the transceiver 250 from the control device. The user 105 may wear the earphones 255 permanently while wearing the device 200 or may take off the earphones 255 when he does not use them.

In a certain embodiment, the cable 215 connecting the earpieces 205, 210 and the cord 260 may be the same element. In this embodiment, the length of the cord 260 may be regulated by winding the cord 260 to the winding means.

In certain embodiments, the device 200 may comprise at least one sensor mounted to the nosepiece portion, the right earpiece 205 or the left earpiece 210 and configured to sense the one or more commands of the user 105. The sensor may include at least one microphone 265, at least one eye-tracking unit, and at least one motion sensing unit. The microphone 265 may sense the voice command of the user 105 and communicate it to the transceiver 250. The eye-tracking unit may track an eye movement of the user 105, generate a command based on the eye movement, and communicate the command to the transceiver 250. The motion sensing unit may sense motion of the device 200 about a horizontal or vertical axis. In particular, the motion sensing unit may sense motion of the right nosepiece 220, the left nosepiece 225, the right earpiece 205 or the left earpiece 210. The user 105 may give commands by moving the device 200, for example, by moving the head of the user 105. The user 105 may choose one or more ways to give commands: by voice, by eye movement, by head movement, for example, by nodding or shaking the head, or use all these ways simultaneously.

In certain embodiments, the device 200 may comprise at least one camera (not shown) mounted to the nosepiece portion, the right earpiece 205 or the left earpiece 210. The camera may include one or more of the following: a digital camera, a mini-camera, a motion picture camera, a video camera, a still photography camera, and so forth. The camera may be configured to take a photo or record a video. The camera may communicate the captured photo or the video to the transceiver 250. The camera may be configured to perform simultaneously video recording and image capturing. In further embodiments, the device 200 may comprise at least five cameras mounted on any side of the device 200 and directed in a way allowing capture of all areas around the device 200. For example, at least five cameras may be mounted on front, rear, top, left and right sides of the device 200. The areas captured by the front-, rear-, top-, left- and right-side cameras may be displayed on the display 240 simultaneously or one by one. Furthermore, the user 105 may select, for example, by voice command, one of the cameras, and the data captured by the selected camera may be shown on the display 240. In further embodiments, the camera may be configured to allow focusing on an object selected by the user 105, for example, by voice command.

The camera may be configured to scan a barcode. Scanning a barcode may involve capturing an image of the barcode using the camera. The scanned barcode may be processed by the control device to retrieve the barcode information. Using the camera of the WPD eyeglass device, the user 105 may capture pictures of various cards, tickets, or coupons. Such pictures, stored in the memory unit of the WPD eyeglass device, may comprise data related to captured cards, tickets, or coupons.

One having ordinary skills in the art would understand that the term “scanning” is not limited to printed barcodes having particular formats, but can be used for barcodes displayed on a screen of a PC, smartphone, laptop, another WPD device, and so forth. Additionally, barcodes by be transmitted to and from the WPD eyeglass device electronically. In some embodiments, barcodes may be in the form of an Electronic Product Code (EPC) designed as a universal identifier that provides a unique identity for every physical object (not just a trade item category) anywhere in the world. It should be noted that EPCs are not exclusively used with RFID data carriers. They can be constructed based on reading of optical data carriers, such as linear barcodes and two-dimensional barcodes, such as Data Matrix symbols. For purposes of this document, all optical data carriers are referred to herein as “barcodes”.

In certain embodiments, the device 200 may comprise a memory unit (not shown) mounted to the nosepiece portion, the right earpiece 205 or the left earpiece 210. On a request of the user, the WPD eyeglass device may display data stored in the memory unit of the device 200. In various examples, such data may include a photo or a video recorded by the camera, the information received from the control device, payment information of the user in the form of a scannable barcode, discount or membership cards of the user, tickets, coupons, boarding passes, any personal information of the user, and so forth. The memory unit may include a smart media card, a secure digital card, a compact flash card, a multimedia card, a memory stick, an extreme digital card, a trans flash card, and so forth.

In certain embodiments, the device 200 may comprise a charging unit (not shown) mounted to the nosepiece portion, the right earpiece 205 or the left earpiece 210. The charging unit may be configured to provide power to the elements of the device 200.

In certain embodiments, the device 200 may comprise a vibration unit (now shown). The vibration unit may be mounted to the nosepiece portion, the right earpiece 205 or the left earpiece 210. The vibration unit may generate vibrations. The user 105 may feel the vibrations generated by the vibration unit. The vibration may notify the user 105 about receipt of the data from the remote device, alert notification, and the like.

In certain embodiments, the device 200 may comprise a GPS unit (now shown). The GPS unit may be mounted to the nosepiece portion, the right earpiece 205 or the left earpiece 210. The GPS unit may detect coordinates indicating a position of the user 105. The coordinates may be shown on the display 240, for example, on request of the user 105, stored in the memory unit, or sent to an external device.

In certain embodiments, the device 200 may comprise a teaching unit allowing the user 105, for example, to read books or train his abilities.

In certain embodiments, the control device may include a phone 120 connected to the device 200 wirelessly or by wires. The phone 120 may comprise a SIM card (not shown) provided by the operator of a phone network for authentication of the phone 120 in the phone network. The phone 120 may perform all the functions peculiar to phones, such as receive phone calls, make phone calls, play music, run applications, establish connection with the Internet, perform operations via the Internet, for example, perform on-line payments, scan product codes, and the like.

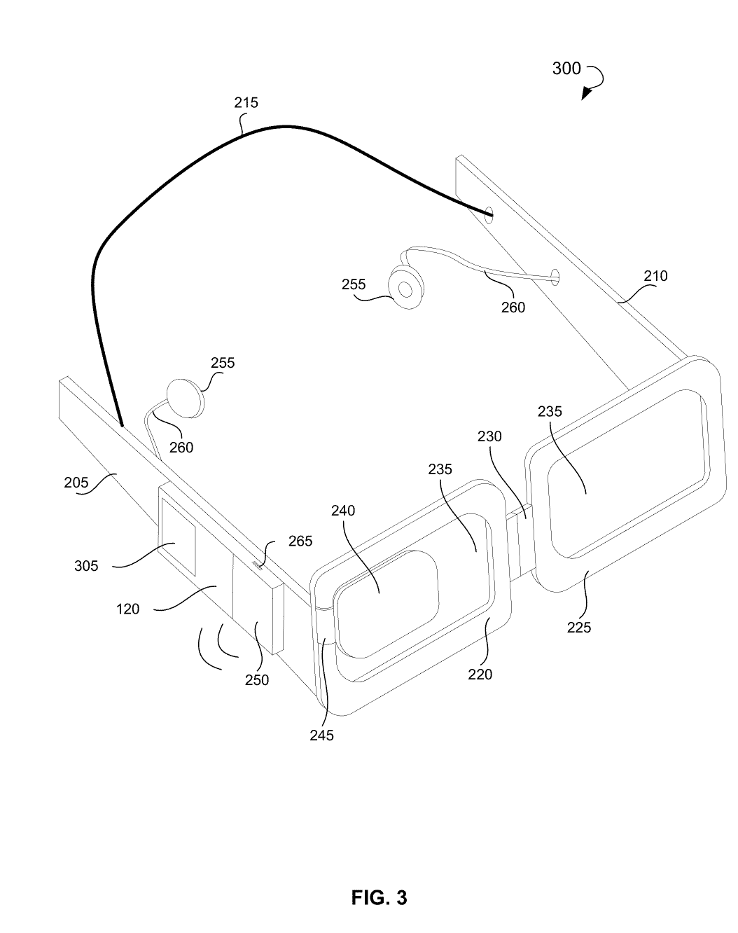

FIG. 3 shows an WPD eyeglass device 200, in accordance with the example embodiment 300. In this embodiment, the control device may include a phone 120 located on the right earpiece 205 or the left earpiece 210 of the device 200. The transceiver 250, the microphone 265, the camera, the memory unit, the vibration unit, the SIM card, or the charging unit may be located inside the phone 120. The phone 120 may perform the same functions as in the embodiment when the phone is wirelessly connected to the device 200, namely receive phone calls, make phone calls, play music, establish connection with a network, such as Internet, perform operations via the network, for example, perform payment by product code scanning, run applications allowing the user 105 to view text, photo or video data, maps, listen to audio data, watch multimedia data, receive and send e-mails, and the like. An operational system running on the phone 120 may include iOS, Android, Firefox, and so forth. The phone 120 may comprise a screen 305. The screen 305 may be of a square, round, rectangular or any other shape. When the device 200 is hanging on the neck of the user 105, the screen 305 may show notifications, for example, about an incoming phone call, an incoming message, low charging of the device 200, and so forth.

In certain embodiments, the phone 120 may be taken out from the device 200 and used as a separate device, for example, as a WPD device worn around the wrist of the user, namely a wrist watch phone. The wrist watch phone may additionally comprise a band adapted to secure the phone 120 around the wrist of the user 105.

In certain embodiments, the WPD eyeglass device 200 may perform hands free phone communication functions, thus, allowing the user to make and receive phone calls without using his hands.

In certain embodiments, the WPD eyeglass device 200 may perform functions of a wearable two-way radio transceiver, for example a walkie-talkie. The wearable two-way radio transceiver may be useful, for example, for police, army, and any other medical, public or recreational organizations.

In certain embodiments, the WPD eyeglass device 200 may enable the user to communicate with cloud services and a software development kit (SDK), and to view cloud advertisements. The cloud services may include cloud application programming interfaces (APIs).

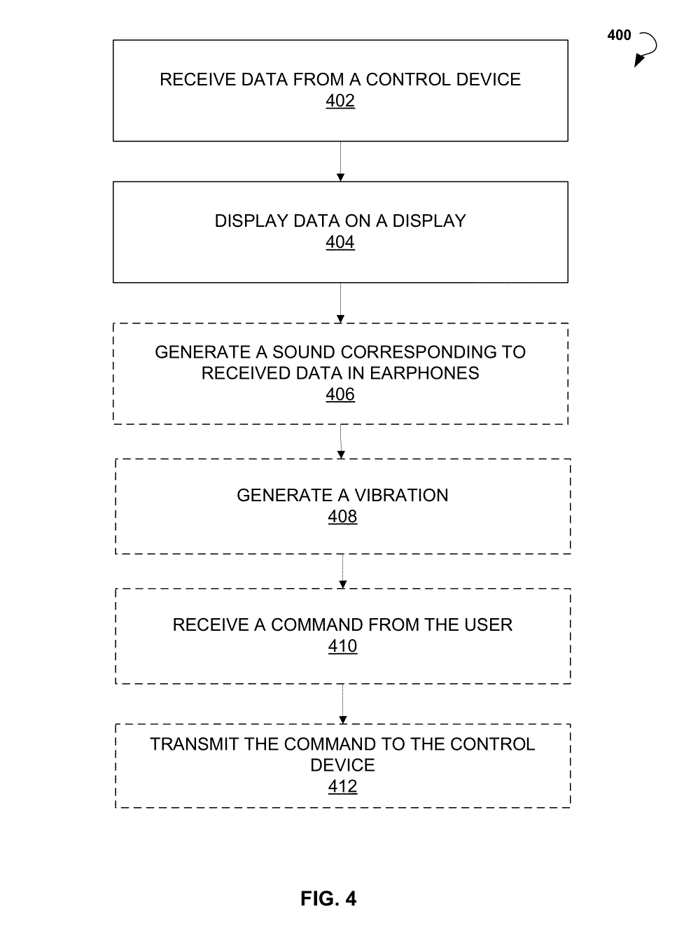

FIG. 4 is a flow chart illustrating a method 400 for interfacing a user 105 with a WPD eyeglass device 200, in accordance with an example embodiment. The method 400 may start with receiving data from a control device at operation 402. The data may be received via a transceiver 250 of the device 200. The data may be displayed to the user 105 on a display 240 of the device 200 at operation 404. The data may include a notification about incoming phone call, a message received by the phone 120, an incoming e-mail, information about current weather conditions, current time, current GPS location of the device 200, alert notification from one of the external devices 125, and the like.

Optionally, the method 400 may include generation of a sound audible in at least one earphone 255 of the device 200 at operation 406. The sound may correspond to the data received from the control device, for example, a voice message or a song. Alternatively, the sound may be a short or repetitive signal notifying the user 105 about receipt of the data. In certain embodiments, the user 105 may be notified about the data received from the control device by a vibration generated by a vibration unit at operation 408.

The user 105 may be notified about the received data by means of one of the following: the display 240, the earphone 255, or the vibration unit. Referring to FIG. 4, the operations 404, 406, and 408 may be performed in any order, either simultaneously or sequentially.

At operation 410, an eye-tracking unit of the device 200 or a microphone 265 may receive a command from the user 105 and communicate the command to the transceiver 250. The command may be a voice command or a command generated on the basis of the eye-movement of the user 105. The command may include a command to accept or decline the call, to read the received message, to write a message, to make a picture, to record video, to record a voice message, to make the phone to run an application, to perform one or more functions of the control device, and so forth. The transceiver 250 may transmit the command to the control device at operation 412.

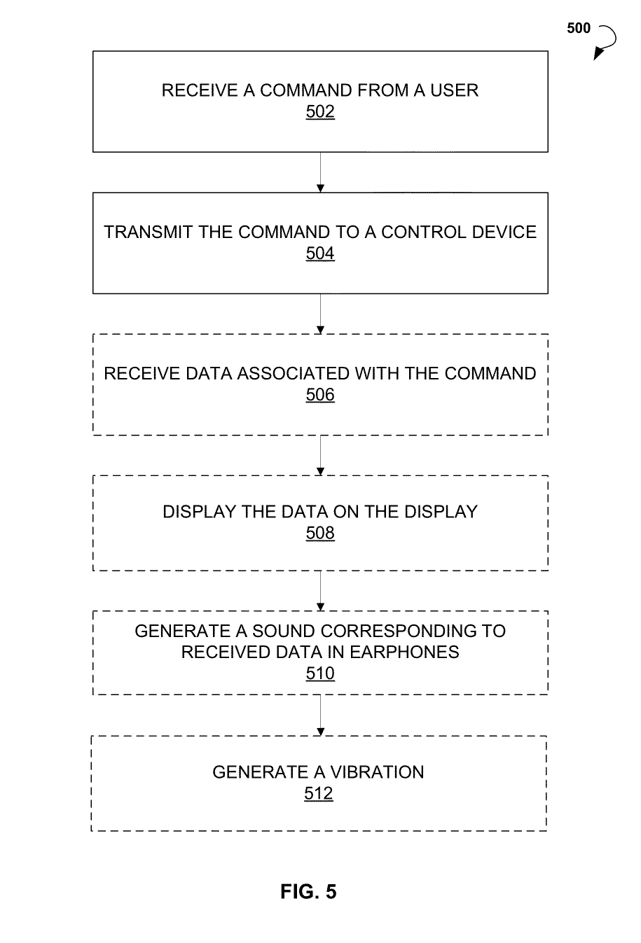

FIG. 5 is a flow chart illustrating a method 500 for interfacing a user 105 with a WPD eyeglass device 200, in accordance with another example embodiment. The method 500 may commence with receiving a command from the user 105 at operation 502. The command may be received via a sensor of the device 200, such as an eye-tracking unit or a microphone 265. The transceiver 250 may transmit the command of the user 105 to a control device at operation 504.

Optionally, at operation 506, the method 500 may include receiving, via the transceiver 250 of the device 200, from the control device, data associated with the command performed by the control device. At operation 508, the data received by the transceiver 250 may be displayed to the user 105 on the display 240 of the device 200. In some embodiments, the sound corresponding to the data received from the control device may be generated in the earphones 265 to get the attention of the user 105 at operation 510. In some embodiments, the sound may be a ring tone. In further embodiments, the user 105 may be notified about the data received from the control device by a vibration generated by a vibration unit of the device 200 at operation 512. The operations 508, 510, and 512 may be performed in any order, either simultaneously or sequentially.

The WPD eyeglass device may be used for facilitating mobile device payments using product code scanning. The user may want to obtain information encoded in a barcode, for example, in a retail shop, cinema, club, sports facility, and the like. In such case, the user may scan the barcode using a camera of the WPD device 200. The scanned barcode may be processed by the control device, for example, a phone, to retrieve the encoded information, with may include a text, an URL, payment information, or other data. If the encoded information contains an URL, the WPD device 200 may communicate with the network, such as Internet, to follow the URL. In some embodiments, the user may allow or deny following the URL retrieved from the barcode.

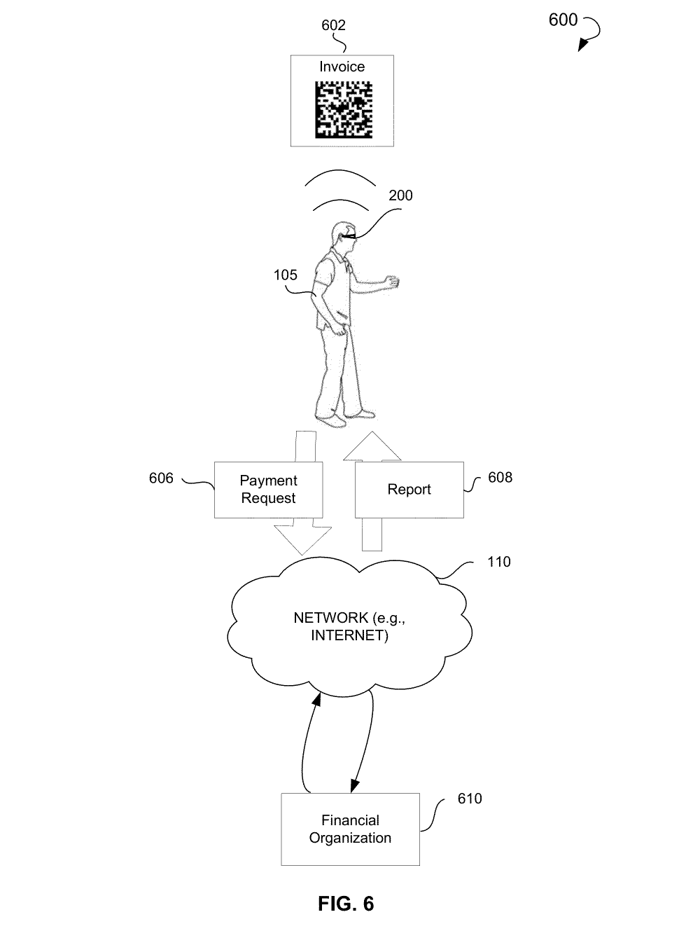

In a certain embodiment, the user may give a command, for example, by voice or by eye movement, to scan a product barcode and make a payment according to payment information encoded in the barcode. One example embodiment of the method 500 in respect of facilitating mobile device payments will now be illustrated by FIG. 6.

FIG. 6 shows payment 600 using a payment card, in accordance with some embodiments. The user 105 gives a command, for example, by voice or by eye movement, to scan a barcode of an invoice 602. The transceiver of the WPD eyeglass device 200 transmits a command to a phone unit mounted on the device 200 to start scanning of the barcode by the camera of the WPD eyeglass device 200. The user 105 receives invoice data by scanning the barcode of the invoice 602 using the camera of the WPD eyeglass device 200. The invoice 602 may encode payment request information, such as receiving account, amount to be paid, and so forth. However, in some embodiments, the amount to be paid may be provided by the user 105.

To pay the invoice 602, the user may choose to pay electronically using the payment data stored on the WPD device or by a payment card. To pay using the payment card, the user may dispose the payment card in front of the camera of the WPD device. Information about the payment card is stored in the memory unit of the WPD eyeglass device or is reached via the Internet. After capturing the image of the payment card by the camera, the WPD eyeglass device receives payment data associated with the payment card. The WPD eyeglass device generates a payment request based on the payment data of the payment card and the payment request information of the invoice 602. Based on the payment request information and payment data of the user 105, the WPD eyeglass device may send a payment request 606 to a financial organization 610 associated with the payment data of the payment card.

The payment request 606 may be then sent via the network 110 to the financial organization 610. The financial organization 610 may process the payment request 606 and either perform the payment or deny it. Then, a report 608 may be generated and sent to the WPD eyeglass device via the network 110. The report may inform user 105 whether the payment succeeded or was denied. The user 105 may be notified about the report by showing the report on the display of the device 200, playing a sound in earphones of the device 200, or by generating a vibration by a vibration unit of the device 200.

Thus, various devices and methods for interfacing a user with a WPD eyeglass device have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A wearable personal digital eyeglass device comprising:
a right earpiece and a left earpiece, wherein the right earpiece and the left earpiece are connected by a cable;
a nosepiece portion, wherein the nosepiece portion consists of a right nosepiece and a left nosepiece connected to each other by a connector, wherein the right nosepiece is connected to the right earpiece and the left nosepiece is connected to the left earpiece;
a display mounted to the nosepiece portion, the right earpiece, or the left earpiece and configured to display data to a user;
a transceiver mounted to the nosepiece portion, the right earpiece or the left earpiece and configured to receive data from a control device, receive one or more commands of the user, and transmit the data and the one or more commands to the control device;
at least one earphone mounted to the right earpiece or the left earpiece;
at least one sensor mounted to the nosepiece portion, the right earpiece or the left earpiece, configured to sense the one or more commands of the user and communicate the one or more commands of the user to the transceiver;
at least one camera mounted to the nosepiece portion, the right earpiece or the left earpiece.

2. The device of claim 1, wherein the cable includes a digital cable, a strap, a string, and a cord.

3. The device of claim 1, the device further comprising a winding means connected to the cable for winding the cable.

4. The device of claim 1, wherein the at least one sensor includes at least one microphone configured to sense a voice command of the user, at least one motion sensing unit configured to sense a head movement command of the user, and at least one eye-tracking unit configured to track an eye movement command of the user.

5. The device of claim 1, wherein the connector includes coupling magnets, a clasp, and a hook and loop lock.

6. The device of claim 1, wherein the nosepiece portion has one or more lens opening.

7. The device of claim 6, the device further comprising at least one lens located in the lens opening.

8. The device of claim 7, wherein at least one lens is selected according to real eye vision of the user.

9. The device of claim 1, wherein the display is configured to display 3D format data.

10. The device of claim 1, wherein the display is configured to show a at least a 2-inch virtual display.

11. The device of claim 1, wherein the display is configured to display simultaneously data requested by the user and a picture of the real world.

12. The device of claim 1, wherein the cameras are configured to capture front-, rear-, top-, left- and right-side areas around the device.

13. The device of claim 1, wherein the camera is configured to perform simultaneously video recording and image capturing.

14. The device of claim 1, wherein the camera is configured to scan a barcode, the scanned barcode being processed by the control device to retrieve the barcode information.

15. The device of claim 14, wherein the barcode information includes payment information.

16. The device of claim 1, the device further comprising one or more of the following: a memory unit, a charging unit, a vibration unit, and a GPS unit mounted to the nosepiece portion, the right earpiece or the left earpiece.

17. The device of claim 1, wherein the control device includes a phone, wherein the phone is wirelessly connected to the device.

18. The device of claim 1, wherein the control device includes a phone located on the right earpiece or the left earpiece, wherein the transceiver is located inside the phone.

19. The device of claim 18, wherein the phone comprises a screen.

20. The device of claim 18, wherein the phone is taken out from the right earpiece or the left earpiece and is used as a separate device, wherein the separate device includes a wrist watch phone.

21. The device of claim 18, wherein the phone has an operational system, wherein the operation system includes iOS, Android, and Firefox.

22. The device of claim 18, wherein the phone is configured to establish connection with a network to view text, photo or video data, maps, listen to audio data, watch multimedia data, receive and send e-mails, and perform payments.

23. The device of claim 18, wherein the phone is configured to communicate with cloud services.

24. The device of claim 18, wherein the phone is configured to communicate with a software development kit.

25. The device of claim 18, wherein the device is configured to perform hands free phone communication functions.

26. The device of claim 18, wherein the device is configured to perform functions of a wearable two-way radio transceiver.

27. A method for interfacing a user with a wearable personal digital eyeglass device, the wearable personal digital eyeglass device comprising the wearable personal digital eyeglass device of claim 1, and the method comprising:
receiving, via a transceiver of the wearable personal digital eyeglass device, data from a control device;
displaying the data to the user on a display of the wearable personal digital eyeglass device.

28. The method of claim 27, further comprising:
generating a sound audible in at least one earphone of the wearable personal digital eyeglass device, wherein the sound corresponds to the data received from the control device.

29. The method of claim 27, further comprising:
generating a vibration via a vibration unit of wearable personal digital eyeglass device.

30. The method of claim 27, further comprising:
receiving from the user, via an eye-tracking unit of the wearable personal digital eyeglass device, a command generated on the basis of the eye-movement of the user;
transmitting, via the transceiver of the wearable personal digital eyeglass device, the command to the control device.

31. The method of claim 27, further comprising:
receiving, via a microphone of the wearable personal digital eyeglass device, a voice command from the user;
transmitting, via the transceiver of the wearable personal digital eyeglass device, the voice command to the control device.

32. A method for interfacing a user with an wearable personal digital eyeglass device, the wearable personal digital eyeglass device comprising the wearable personal digital eyeglass device of claim 1, and the method comprising:
receiving, via a sensor of the wearable personal digital eyeglass device, a command from the user;
transmitting, via a transceiver of the wearable personal digital eyeglass device, the command to a control device.

33. The method of claim 32, further comprising:
receiving, via the transceiver of the wearable personal digital eyeglass device, from the control device, data associated with the command performed by the control device;
displaying the data to the user on the display of the wearable personal digital eyeglass device.

34. The method of claim 32, further comprising:
generating a sound audible in at least one earphone of the wearable personal digital eyeglass device, wherein the sound corresponds to the data received from the control device.

35. The method of claim 32, further comprising:
generating a vibration via a vibration unit of wearable personal digital eyeglass device.
